(19) United States
(12) Patent Application Publication
(10) Pub. No.: US 2017/0013137 A1
(43) Pub. Date: Jan. 12, 2017

(54) TECHNIQUES TO DETECT VIDEO TRANSFER FROM NETWORK USAGE

(71) Applicant: Facebook, Inc., Menlo Park, CA (US)

(72) Inventors: Roee Eilat, Tel AViv (IL); Omri Gindi, Tel Aviv (IL)

(73) Assignee: FACEBOOK, INC., Menlo Park, CA (US)

(21) Appl. No.: 14/792,444

(22) Filed: Jul. 6, 2015

(51) Int. Cl. H04M 15/00; H04L 12/14; H04L 12/26

(52) U.S. Cl. CPC H04M 15/8214; H04M 15/68; H04L 43/16; H04L 12/1435

(57) ABSTRACT

Techniques to detect video transfer from network usage are described. Some embodiments are particularly directed to techniques detect that a user and a particular application is engaging in video transfer, particularly a video download, through monitoring the network usage of applications and whether applications are foregrounded. In one embodiment, an apparatus may comprise a network usage monitoring component operative to determine a foreground application on a device; monitor network usage for the foreground application on the device; and determine whether the network usage for the foreground application exceeds a video usage signature threshold; and a logging component operative to log video activity in a video usage time series log where the network usage for the foreground application exceeds the video usage signature threshold. Other embodiments are described and claimed.

### BACKGROUND

Mobile devices may run applications, commonly known as “apps,” on behalf of their users. These apps may be distributed through one or more app repositories provided by the first-party manufacturer of the device or operating system or provided by a third party. These apps may engage in network activity on the mobile device, such as through a cellular or Wi-Fi network. This network activity may include transferring—uploading or downloading—video content.

Cellular data networks may use metered data. The amount of data transferred across a cellular data network may be monitored and debited against a user allocation of data. Similarly, the amount of data transferred across a cellular data network may be monitored and the user billed a fee based on the amount.

### SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Various embodiments are generally directed to techniques to detect video transfer from network usage. Some embodiments are particularly directed to techniques detect that a user and a particular application is engaging in video transfer, particularly a video download, through monitoring the network usage of applications and whether applications are foregrounded. In one embodiment, for example, an apparatus may comprise a network usage monitoring component operative to determine a foreground application on a device; monitor network usage for the foreground application on the device; and determine whether the network usage for the foreground application exceeds a video usage signature threshold; and a logging component operative to log video activity in a video usage time series log where the network usage for the foreground application exceeds the video usage signature threshold. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a video transfer detection system.

FIG. 2A illustrates an example video usage time series log.

FIG. 2B illustrates an example foreground application time series log.

FIG. 3 illustrates an embodiment of the video transfer detection system analyzing a network usage record.

FIG. 4 illustrates an embodiment of the monitoring application and the analysis server performing video usage analysis.

FIG. 5 illustrates an embodiment of a logic flow for the system of FIG. 1.

FIG. 6 illustrates an embodiment of a centralized system for the system of FIG. 1.

FIG. 7 illustrates an embodiment of a distributed system for the system of FIG. 1.

FIG. 8 illustrates an embodiment of a computing architecture.

FIG. 9 illustrates an embodiment of a communications architecture.

FIG. 10 illustrates an embodiment of a radio device architecture.

### DETAILED DESCRIPTION

Users of network-connected computer devices engage in various network activity. Network-connected computer devices, particularly mobile devices, may be connected to a metered data network, in which data access is priced, at least in part, according to an amount of data transferred over the network. Users of these devices may benefit from being informed of the amount with which they use metered data networks—and possibly also with which they use non-metered data networks—so as to empower the users to manage their use of the data networks and make informed decisions about what applications and functions they use on their device.

Informing users about their use of data networks may be particularly beneficial where the usage information is categorized according to types of activity. For example, a user informed of the amount of their access to a metered network that is put towards various activities may inspire users to refrain from one sort of behavior on metered networks (such as due to it using a large quantity of network data transfer) and reassure users in engaging in another sort of behavior on metered networks (such as due to it using a relatively small quantity of network data transfer). A description of the network usage of various activities can be broken down according to various schemes for dividing the user's overall behavior into specific activities.

One perspective on a user's network usage may consist of individually noting the amount put towards each of the applications on their device that engage in network activity: a specific quantity of network data transfer (e.g., kilobytes (KB), megabytes (MB), gigabytes (GB)) used over a particular time period (e.g., daily, weekly, monthly, per subscription period) for each application engaging in network access. Another perspective on the user's network usage may consist of not the amount put towards activities associated with significant network usage, such as transferring (upload and/or downloading) video content. Such a view on network usage may be global—what quantity of data transferred per time period devoted to video transfer across all applications on the device—or per-application—what quantity of data transferred per time period devoted to video transfer for each application on the device that engaged in video transfer.

Similarly, data network providers and network service providers may have an interest in receiving statistics on how users are employing their devices for network access. Providers may orient the services they offer, how their services are configured, and how their services are promoted to users based on how users are consuming network resources. For example, a network service provider that operates, at least in part, according to an application installed on client devices may benefit from know what portion of a user's video activity is performed using their application and what portion of a user's video activity is performed using other applications. The network service provider may be able to determine the extent to which users use their own service simply from monitoring activity on their own server devices, but a comparison with other services may be achieved by monitoring the network activity on a user's device. If users increase their use of the service's video offerings the network service provider may benefit from knowing whether this results from an overall increase in the use of video services or whether this increase is specific to or centralized to that particular service. In general, comparisons of growth or expansion may empower the network service provider to learn how they are performing overall and relative to other services and make decisions for the future based on this knowledge.

Where a network service provider, data network provider, or other entity has an application locally installed and executing on a client device they may be able to perform the collection of this information in the background, in addition to whatever functionality an application may provide to the user of the device. In order to avoid engaging in excessive network usage in reporting network usage, the information logged by an application may be stripped to the basic details for transmission to a logging server for the network service. As a result, the embodiment herein can improve networks service provider, data network provider, and user knowledge about user activity without creating significant additional network usage.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

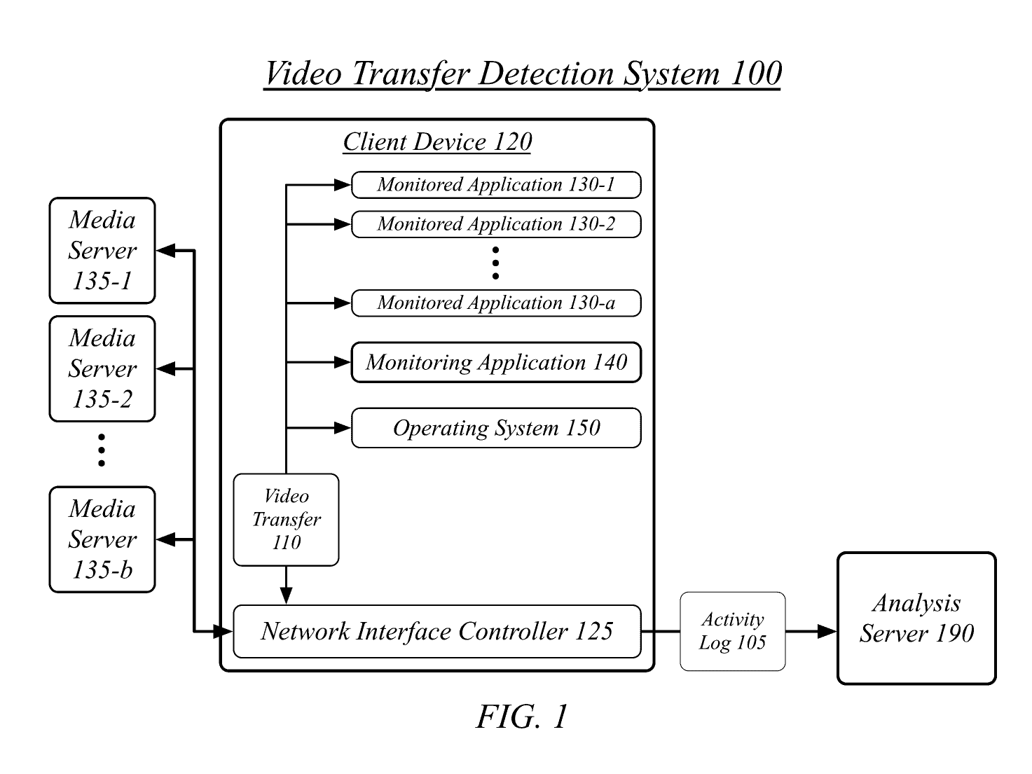

FIG. 1 illustrates a block diagram for a video transfer detection system 100. In one embodiment, the video transfer detection system 100 may comprise a computer-implemented system having software applications comprising one or more components. Although the video transfer detection system 100 shown in FIG. 1 has a limited number of elements in a certain topology, it may be appreciated that the video transfer detection system 100 may include more or less elements in alternate topologies as desired for a given implementation.

A client device 120 may correspond to a mobile device, personal computer device, portable computer device, desktop computer device, tablet device, smartphone device, and/or any other form of computing device. Client device 120 may be associated with a particular user and access one or more data networks. One or more of the one or more data networks may be metered networks or other networks for which a user and/or other entity is interested in receiving information about the user's network activity and network usage. Where the client device 120 accesses multiple data networks—such as one or more cellular data networks and/or one or more Wi-Fi networks—a user's network usage may be categorized at least in part according to the network or type of network (e.g., grouping together all network usage performed on any Wi-Fi network) on which the usage occurs.

Video transfer detection system 100 may include an authorization server (or other suitable component(s)) that allows users to opt in to or opt out of having their actions logged by video transfer detection system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of video transfer detection system 100 and other elements of a social-networking system through blocking, data hashing, anonymization, or other suitable techniques as appropriate. For instance, a user may be empowered to configure privacy settings determining whether network usage, such as video access, is logged by the video transfer detection system 100 and analyzed. In some embodiments, a user may be presented with information regarding may be collected and how that information may be used, such as informing the user that collected information may be anonymized prior to analysis. A user may be provided with the opportunity to accept or reject the logging and analysis of network usage prior to any logging and analysis of their network usage by the video transfer detection system 100.

The client device 120 may communicate with other devices using wireless transmissions to exchange network traffic. Exchanging network traffic, such as may be included in the exchange of messaging transactions, may comprise transmitting and receiving network traffic via a network interface controller 125 (NIC). A NIC comprises a hardware component connecting a computer device, such as client device 120, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API). The network interface controller 125 may be used for the network activities of the embodiments described herein, including the interoperation of the monitored applications 130, media servers 135, monitoring application 140, and analysis server 190 through network communication. For example, the monitoring application 140 transmitting an activity log 105 to an analysis server 190 may correspond to using the network interface controller 125 for network access to a communications network for the transmission of the activity log 105. Similarly, a monitored application of a plurality of monitored applications 130 transferring (uploading or download) a video transfer 110 with a media server of a plurality of media servers 135 may correspond to using the network interface controller 125 for network access to a communications network for the transmission of the video transfer 110.

Monitored applications 130 may correspond to some or all of the applications installed, otherwise stored, or otherwise available for execution on the client device 120. The monitored applications 130 may include applications included with the client device 120 by the provider of the client device 120, reseller of the client device 120, provider of the operating system 150, provider of cellular service to the client device 120, or other entity configuring the client device 120 prior to distribution to its end user. The monitored applications 130 may include applications installed by a user of the client device 120. In some cases, a user may have installed one or more of the monitored applications 130 by downloading the applications from an application repository.

The monitored applications 130 may include applications for one or more of searching media content, discovering media content, sharing media content, storing media content, accessing media content, modifying media content, and combining media content. One or more of the monitored applications 130 may be associated with one or more media services, either as a dedicated application for a particular media service, an application interoperating with a plurality of media services, or generally an application operative to operative to retrieve or submit media content to or from a media service. Each of the media services may provide one or more media servers 135 for storing, retrieving, and generally exchanging media content. It will be appreciated that media content, such as video content, may be transferred peer-to-peer such that one or more of the media servers 135 comprise other user client devices. The media servers 135 may distribute media content to or receive media content from one or more of the monitored applications 130. The media content may comprise video content and therefore be transferred as a video transfer 110.

The monitoring application 140 may be included with the client device 120 or may be installed by a user of the client device 120. In some embodiments, the monitoring application 140 may be a special-purpose application directed specifically to the monitoring of network usage or, more broadly, application activity, without providing separate functionality to the user of the client device 120. In some embodiments, the monitoring application 140 may also empower the user to view usage statistics regarding the monitored applications 130 on the client device 120. In some embodiments, the monitoring application 140 may empower the user of the client device 120 to view, select, purchase, and configure data network packages for the providing of data services, such as to purchase packages to reduce or remove the network-usage-based fees associated with the use of particular applications or particular activities. In some embodiments, the monitoring application 130 may also provide the user with additional functions, such as messaging, access to a social network, web-browsing, media viewing, media capture, media uploading, or any other functions.

The monitoring application 140 may be operative to monitor the network usage of the monitored applications 130 on the client device 120. In some embodiments the monitoring application 130 may monitor the network usage of all the applications on a client device 120, with the monitored applications 130 therefore comprising all of the applications on the client device 120. In other embodiments the monitoring application 130 may monitor only a portion of the applications on the client device 120, with the monitored applications 130 therefore comprising that portion of the applications on the client device 120. The user of the client device 120 may be empowered to select which applications, if any, on the client device 120 the monitoring application 140 is to monitor, with the monitored applications 130 comprising this selected portion of the applications on the client device 120.

The monitoring application 140 may detect a video transfer 110 of a plurality of video transfers performed by one or more of the monitored applications 130 on the client device 120. The monitoring application 140 may generate an activity log 105, the activity log 105 comprising video usage information for the monitored applications 130 on the client device 120. The activity log 105 may comprise a video usage time series log indicating during what time periods the monitored applications 130 were used for video transfer. The activity log 105 may comprise a foreground application time series log indicating which of the monitored applications 130 is the foreground application, if any, on the client device 120.

The monitoring application 140 may transmit the activity log 105 to an analysis server 190. The analysis server 190 may be operative to receive the activity log 105 and to generate network usage statistics, video transfer statistics, and/or video streaming statistics for the monitored applications 130 on the client device 120. The analysis server 190 may provide the statistics to the user of the client device 120, such as via the monitoring application 140. The analysis server 190 may additionally or alternatively provide the statistics to other entities. The providing of the statistics to other entities may be controlled according to privacy policies explicitly accepted by the user of the client device 120 prior to any monitoring of network usage or collecting of network usage information.

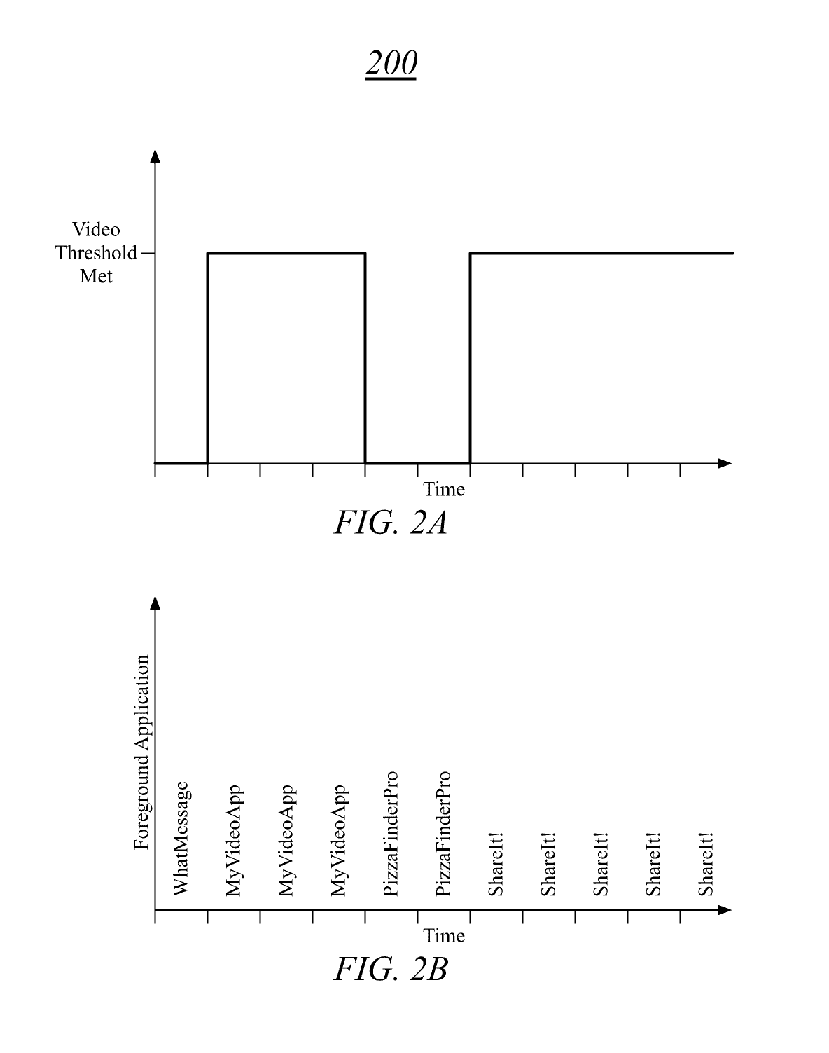

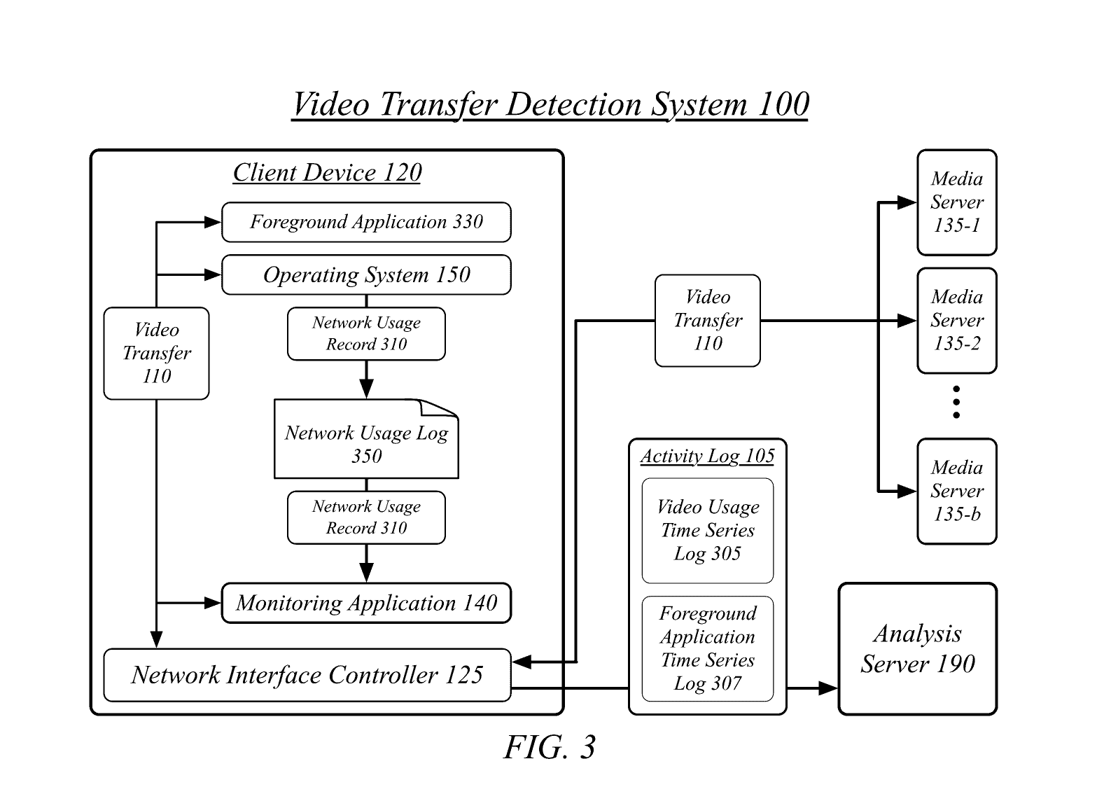

FIG. 2A illustrates an example video usage time series log. FIG. 2B illustrates an example foreground application time series log. The video usage time series log of FIG. 3A and the foreground application time series log of FIG. 2B may together comprise the contents of the activity log 105 transmitted to the analysis server 190 by the monitoring application 140.

In order to conserve a user's use of a data network the monitoring application 140 may exclude from the activity log 105 any information not useful to the analysis server 190 in determining the amount of time each of the monitored applications 130 is used for viewing video content. As such, the video usage time series log may comprise a two-state (yes or no, e.g. binary) indication of whether a video threshold has been met in regards to network usage by any monitored application. The video usage time series log may comprise an indication, for each of a plurality of time segments, of whether a current foreground application has met a video threshold for network usage. It will be appreciated that various techniques may be employed to reduce the storage spaced used for storing the video usage time series log such that there is not a distinct recorded indication for each time segment. For instance, where multiple sequential time segments are associated with a same state, a collective indication of their state may be used. In general, the video usage time series log comprising an indication for each of the plurality of time segments of whether a current foreground application has met a video threshold for network usage may correspond to the video usage time series log comprising information operative to determine for each of the plurality of time segments whether a video threshold was met.

The foreground application time series log may comprise a recording of what application was in the foreground on the client device 120 for each of a series of time segments. An application being in the foreground may correspond to the application being visible on the screen of the client device 120. This may correspond both to the application being the active application on the client device 120 and the screen of the client device 120 being active (i.e., powered) and unlocked (i.e., not displaying a locked screen). Applications may be identified in the foreground application time series log according to a variety of techniques. The monitoring application 140 may associate each of the applications with a distinct identifier, the identifiers used to distinctly identify a particular application. In some embodiments, the identifiers may be assigned by an application repository or other application authority associated with the providing of applications to client devices. In other embodiments, the identifiers may be assigned by a provider of the video transfer detection system 100. It will be appreciated that various techniques may be employed to reduce the storage spaced used for storing the foreground application time series log such that there is not a distinct recorded indication for each time segment. For instance, where multiple sequential time segments are associated with a same foreground application, a collective indication of the foreground application may be used across the multiple sequential time segments. In general, foreground application time series log comprising a recording of what application was in the foreground on the client device 120 for each of a series of time segments may correspond to the foreground application time series log comprising information operative to determine for each of the plurality of time segments what application was in the foreground on the client device 120.

The video usage time series log and foreground application time series log may use a comment time series—a common division of time into segments—to empower a combined analysis of the logs. The time segments used in each of the logs may be of a same length, such as five seconds. The beginning and end of each of the time segments for the video usage time series log may match the beginning and end of each of the time segments for the foreground application time series log so that for a particular instance in time both the foreground application and whether a video threshold was met may be determined.

As illustrated in FIG. 2B, a sequence of changing applications took the foreground on the client device 120, including “WhatMessage,” “MyVideoApp,” “PizzaFinderPro,” and “ShareIt!.” As illustrated in FIG. 2A, some of these foreground applications were inferred, based on meeting a video threshold, to have engaged in the transfer of a video. Particularly where the video transfer detection system 100 is oriented to the determination of whether a video is being streamed for viewing by the user, the video usage time series log may only indicate an inferred transfer of video when an application meeting a video threshold for network usage is the foreground application, on the rationale that video would only be streamed for viewing when the streaming application is viewable and therefore in the foreground.

A combined analysis of the video usage time series log and the foreground application time series log indicates that during the second through fourth time segment a video threshold was met and the “MyVideoApp” application was in the foreground. As such, an analysis may indicate that the “MyVideoApp” application engaged in video streaming for the time period corresponding to the second through fourth time segment. Similarly, the seventh through eleventh are associated with both a video threshold being met and the “ShareIt!” application being in the foreground, thereby implying that the “ShareIt!” application engaged in video streaming for the time period corresponding to the seventh through eleventh time period. In contrast, neither the first nor fifth through sixth time segment are indicated as having a foreground application meeting a video threshold, indicating that, at least during the illustrated logged period, that the “WhatMessage” application and “PizzaFinderPro” application did not engage in video transfer. As such, a combined analysis of a video usage time series log indicating whether a foreground application engaged in network usage that met a video threshold and a foreground application time series log recording foreground applications may be used to determine the time periods in which video transfer may be inferred and the applications responsible for the video transfer.

FIG. 3 illustrates an embodiment of the video transfer detection system 100 analyzing a network usage record 310.

A foreground application 330 may engage in video playback of a video stream on the client device 120. The video transfer 110 may comprise the transmission of a video stream from a source media server of a plurality of media servers 135 via a data network to the client device 120. The client device 120 may receive the video transfer 110 via the NIC 125 for the client device 120. The foreground application 330 may receive the video transfer 110 and play the video content streamed via the video transfer 110 on the display of the client device 120. The foreground application 330 may comprise one of the monitored applications 130 described with reference to FIG. 1.

The operating system 150 may mediate the performance of the video transfer 110 by the foreground application 330. The operating system 150 may provide application programming interfaces (APIs), libraries, or other software tools to provide access to the use of the NIC 125 and therefore a data network. The operating system 150 may therefore be able to observe whether any application on the client device 120 is performing a network transfer and the amount of such a network transfer.

The operating system 150 may monitor the network usage of the client device 120 and the applications on the client device 120, including the monitored applications 130 and the foreground application 330. The operating system 150 may record observed network usage in a network usage log 350. The operating system 150 may generate a network usage record 310 recording the quantity of network transfer used within a polling period and store the network usage record 310 in a network usage log 350, the network usage log 350 comprising a listing of network usage records. A polling period may correspond to a regular and repeated interval of time over which the operating system 150 measures network usage and records the measured network usage in a network usage record 310.

The monitoring application 140 may read the network usage log 350 and retrieve the network usage record 310. The monitoring application 140 may determine, for each network usage record 310 retrieved from the network usage log 350, whether the network usage record 310 corresponds to a foreground application 330. Where the network usage record 310 corresponds to a foreground application 330—a monitored application executing in the foreground on the client device 120—the monitoring application 140 may compare the quantity of data transferred during the polling period to a video usage threshold to determine whether the foreground application 330 may be inferred to be engaging in the streaming of video content. Where the video usage threshold is met a positive indication may be recorded in a video usage time series log 305, as described with reference to FIG. 2A.

The current foreground application 330 may be stored in a foreground application time series log 307. As described with reference to FIG. 2A and FIG. 2B, a comparison of the video usage time series log 305 and foreground application time series log 307 may be performed to determine what and for how long different monitored applications 130 on the client device 120 perform video playback for the user of the client device 120. The video usage time series log 305 and foreground applications time series log 307 may be transmitted to an analysis server 190 as an activity log 105. In some embodiments the time segmenting of the video usage time series log 305 and foreground application time series log 307 may correspond to the polling interval used by the operating system in the generation of network usage records for the network usage log 350.

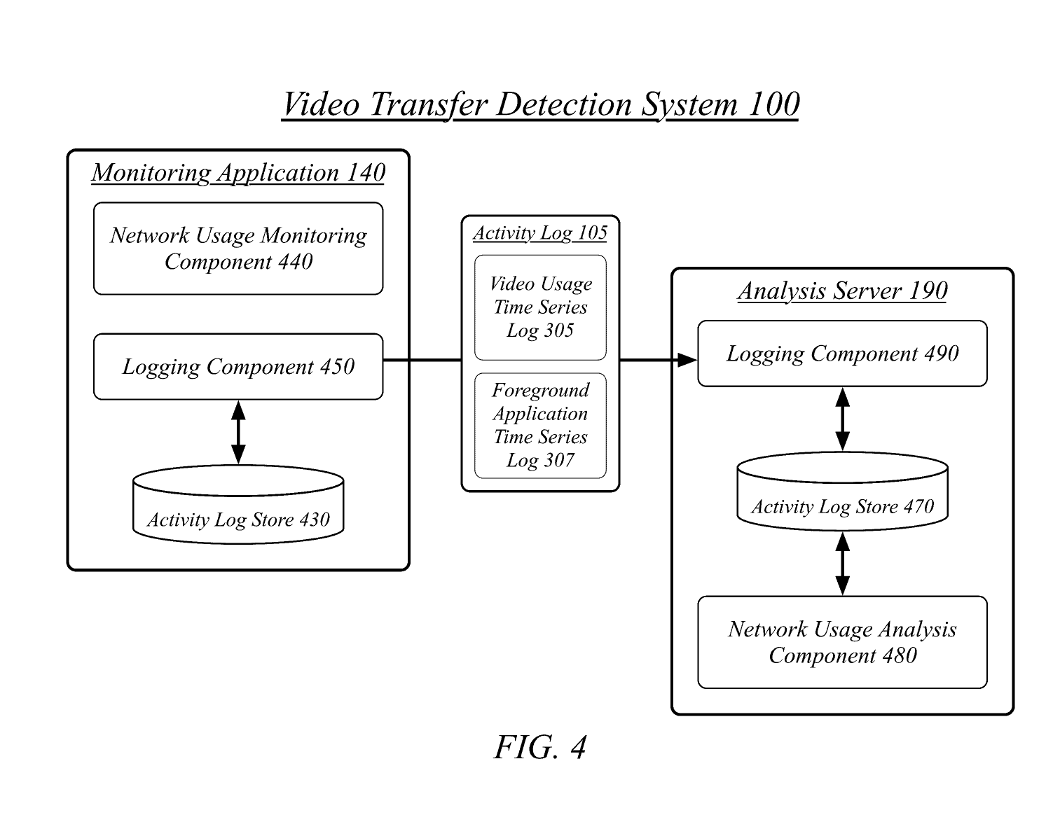

FIG. 4 illustrates an embodiment of the monitoring application 140 and the analysis server 190 performing video usage analysis.

The monitoring application 140 may comprise a network usage monitoring component 440 and a logging component 450. The network usage monitoring component 440 may be generally arranged to monitor the network usage of applications on the client device 120 on which the monitoring application 140 to infer a bandwidth usage—an inference of the instantaneous rate of transfer (e.g., megabytes per second)—for applications on the device. The logging component 450 may be generally arranged to log monitored information in an activity log store 430 and to periodically send digests of the logged information to the analysis server 190 for analysis.

The analysis server 190 may comprise a logging component 490 and a network usage analysis component 480. The logging component 490 may be generally arranged to receive activity logs, such as activity log 105, and to store the receive activity logs in an activity log store 470. The network usage analysis component 480 may be generally arranged to retrieve activity logs from the activity log store 470 and to determine video usage statistics. The network usage analysis component 480 may be generally arranged to generate video usage statistics that are specific to a particular device, such as client device 120. The network usage analysis component 480 may be generally arranged t generate aggregate video usage statistics that reflect video usage across a plurality of client devices, which may include client device 120.

The network usage monitoring component 480 may be operative to determine a foreground application 330 on a client device 120 and to monitor network usage for the foreground application 330 on the client device 120. Monitoring network usage for the foreground application may correspond to accessing an operating system network usage log 350 for the client device 120. The network usage log 350 may comprise records generated by the operating system 150 of the client device 120 of the quantity of data transferred over a network connection for the client device 120, wherein each of the records within the network usage log 350 corresponds to the quantity of data transferred within a particular span of time.

In some cases, the network usage monitoring component 480 may infer what, if any, application is in the foreground rather than receive direct signals as to the foreground application from the operating system 150. For example, the network usage monitoring component 480 may be empowered to receive the current active application, but not an indication of whether the current active application is foreground (i.e., being actively displayed on the screen of the client device 120). The network usage monitoring component 480 may therefore independently determine whether the display for the client device 120 is active and is unlocked. As such, determining the foreground application 330 on a client device 120 may include determining that a display for the device is active and is unlocked.

The network usage monitoring component 440 may be operative to determine whether the network usage for the foreground application 330 exceeds a video usage signature threshold. The logging component 450 may be operative to log video activity in a video usage time series log 305 where the network usage for the foreground application 330 exceeds the video usage signature threshold. The video usage time series log 305 may be periodically or intermittently transmitted to the analysis server 190 for analysis. The video usage time series log 305 may comprise a series of two-state indications (i.e., a symbolic yes or no) of whether the current foreground application was inferred to be engaging in video streaming.

The video usage signature threshold may be a predefined quantity of network usage—a predefined quantity of data transferred over a NIC 125—which, if met or exceeded for a particular polling period, is taken to imply that the associated application, if in the foreground, was streaming video content. In some embodiments, the video usage signature threshold may be defined in terms of the quantity of network usage using a measure of quantity of data: kilobytes, megabytes, gigabytes, etc. In other embodiments, the video usage signature threshold may be defined in terms of an amount of bandwidth—kilobytes per second, megabytes per sec, etc.—with the measure quantity of data divided by the length of the polling period to determine an average bandwidth usage for the polling period.

In some embodiments, the monitoring application 140 may be configured with a plurality of predefined video usage signature thresholds, with each of the predefined video usage signature threshold corresponding to a different scenario or case in which the network usage of a foreground application 330 is being monitored and analyzed. A lower quantity of network usage may comprise a signature for video streaming being performed where other criteria suggest that video streaming is being performed. A higher quantity of network usage may comprise a signature for video streaming being performed where other criteria suggest that video streaming is not being performed. For example, network usage may be associated with a video network service prior to the analysis of its quantity. For instance, the foreground application 330 may be associated with a video network service by virtue as having been identifier as being a video playback application. Alternatively or additionally, the foreground application 330 may be associated with a video network service by virtue of the monitored network activity being with a network service associated with video streaming, such as an online video hosting service. Alternatively or additionally, the foreground application 330 may be associated with a video network service by virtue of being detected as using a video streaming library provided by the operating system 150 on the client device 120. In some cases, the network usage log 350 generated by the operating system 150 may attribute network usage by a video streaming library to a process or thread specifically associated with the video streaming library. In other cases, the network usage log 350 generated by the operating system 150 may attribute network usage by a video streaming library to the application making use of the video streaming library.

The network usage monitoring component 440 may therefore determine whether the network usage is video network service associated and may select the video usage signature threshold based on whether the network usage is video network usage associated. In some embodiments, different video usage signature threshold may be used for different cases that meet the criteria of the network usage being video network usage associated. A default video usage signature threshold may be used where no particular indication is identified of the foreground application 330 or its network usage being associated with a video network service. A lower video usage signature threshold may be used for an application registered with the monitoring application 140 as being used for video streaming or primarily being used for video streaming. A second lower video usage signature threshold may be used for an application identified as communication over the network with a video streaming service. A third lower video usage signature threshold may be used for an application detected as using a video streaming library. A higher video usage signature threshold may be used for applications registered with the monitoring application 140 as engaging in large foreground non-video transfers (e.g., non-video file downloads). It will be appreciated that “lower” and “higher” thresholds may be lower and higher relative to the default video usage signature threshold.

As such, the network usage monitoring component 440 may be operative to determine whether the network usage for the foreground application 330 exceeds the video usage signature threshold using a first video usage signature threshold where the network usage is video network service associated. The network usage monitoring component 440 may be operative to determine whether the network usage for the foreground application 330 exceeds the video usage signature threshold using a second video usage signature threshold where the network usage is not video network service associated, the first video usage signature threshold lower than the second video usage signature threshold.

The video transfer detection system 100 may determine video usage statistics for the client device 120 based on the video usage time series log 305. Video usage statistics may represent an amount of time each application on the client device 120 engages in video transfer and/or video streaming. Video usage statistics may represent an amount of time the client device 120 is used for video transfer and/or video streaming.

The network usage monitoring component 440 may be operative to generate a foreground application time series log 307. The video usage time series log 305 and the foreground application time series log may be indexed to a common polling schedule. The video transfer detection system 100 may be operative to determine application-specific video usage statistics based on a comparison of the video usage time series log and the foreground application time series log.

In some embodiments, the generation of video usage statistics may be performed locally on the client device 120 by a network usage analysis component 480 executing locally on the client device 120. However, in other embodiments the generation of video usage statistics may be performed by a separate server device executing an analysis server 190. The offloading of this analysis to the server device may serve to reduce the computational demands of this monitoring and analysis for the client device 120. As such, the logging component 450 may transmit the video usage time series log 305 to an analysis server 190, the analysis server 190 operative to determine video usage statistics for the device based on the video usage time series log. Where a foreground application time series log 307 is used, the logging component 450 may generate a foreground application time series log 307, the video usage time series log 305 and foreground application time series log 307 indexed to a common polling schedule; transmit the video usage time series log 307 to an analysis server 190; and transmit the video usage time series log 305 to the analysis server 190, the analysis server 190 operative to determine application-specific video usage statistics based on a comparison of the video usage time series log 305 and the foreground application time series log 307. The video usage time series log 305 and the foreground application time series log 307 may be transmitted to the analysis server 190 in a combined package as an activity log 105.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

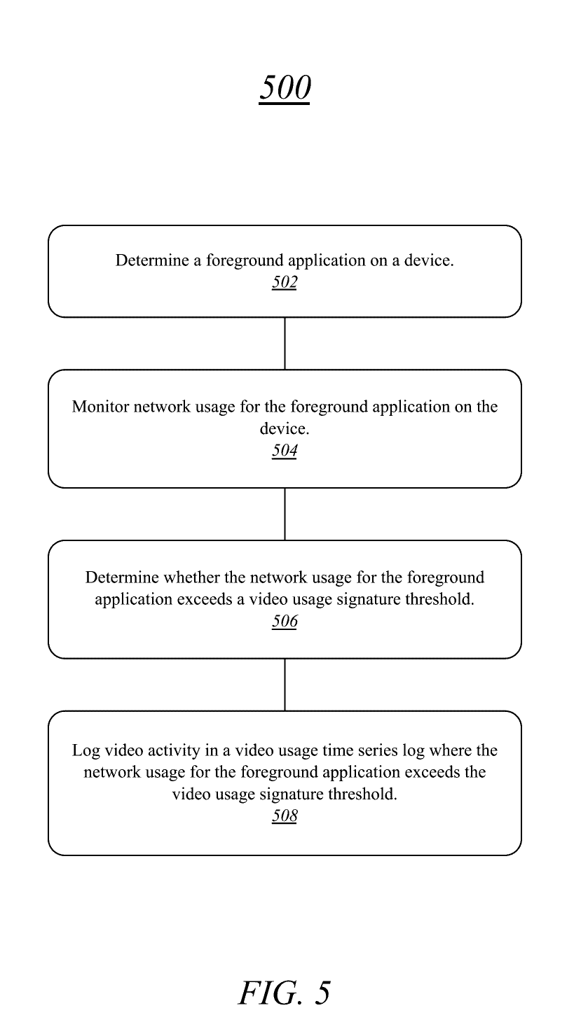

FIG. 5 illustrates one embodiment of a logic flow 500. The logic flow 500 may be representative of some or all of the operations executed by one or more embodiments described herein.

In the illustrated embodiment shown in FIG. 5, the logic flow 500 may determine a foreground application on a device at block 502.

The logic flow 500 may monitor network usage for the foreground application on the device at block 504.

The logic flow 500 may determine whether the network usage for the foreground application exceeds a video usage signature threshold at block 506.

The logic flow 500 may log video activity in a video usage time series log where the network usage for the foreground application exceeds the video usage signature threshold at block 508.

The embodiments are not limited to this example.

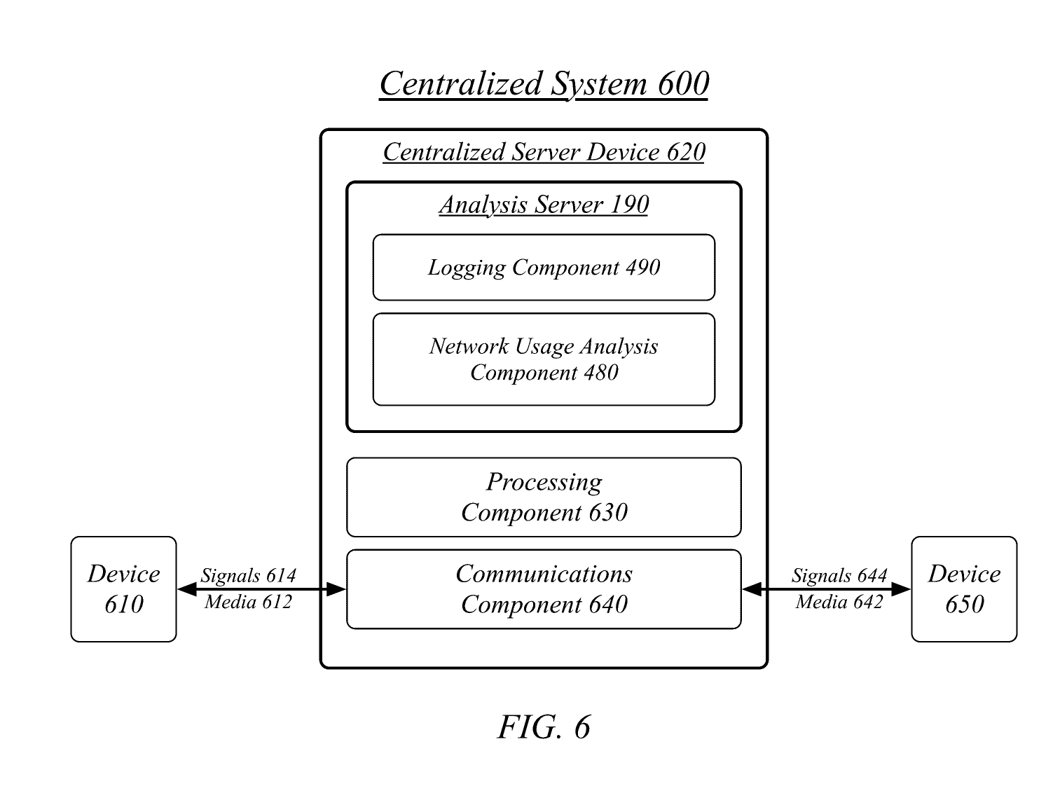

FIG. 6 illustrates a block diagram of a centralized system 600. The centralized system 600 may implement some or all of the structure and/or operations for the video transfer detection system 100 in a single computing entity, such as entirely within a single centralized server device 620.

The centralized server device 620 may comprise any electronic device capable of receiving, processing, and sending information for the video transfer detection system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The centralized server device 620 may execute processing operations or logic for the video transfer detection system 100 using a processing component 630. The processing component 630 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The centralized server device 620 may execute communications operations or logic for the video transfer detection system 100 using communications component 640. The communications component 640 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 640 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 612, 642 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The centralized server device 620 may communicate with other devices 610, 650 over a communications media 612, 642, respectively, using communications signals 614, 644, respectively, via the communications component 640. The devices 610, 650 may correspond to client devices that upload activity logs to the analysis server 190 executing on the centralized server device 620.

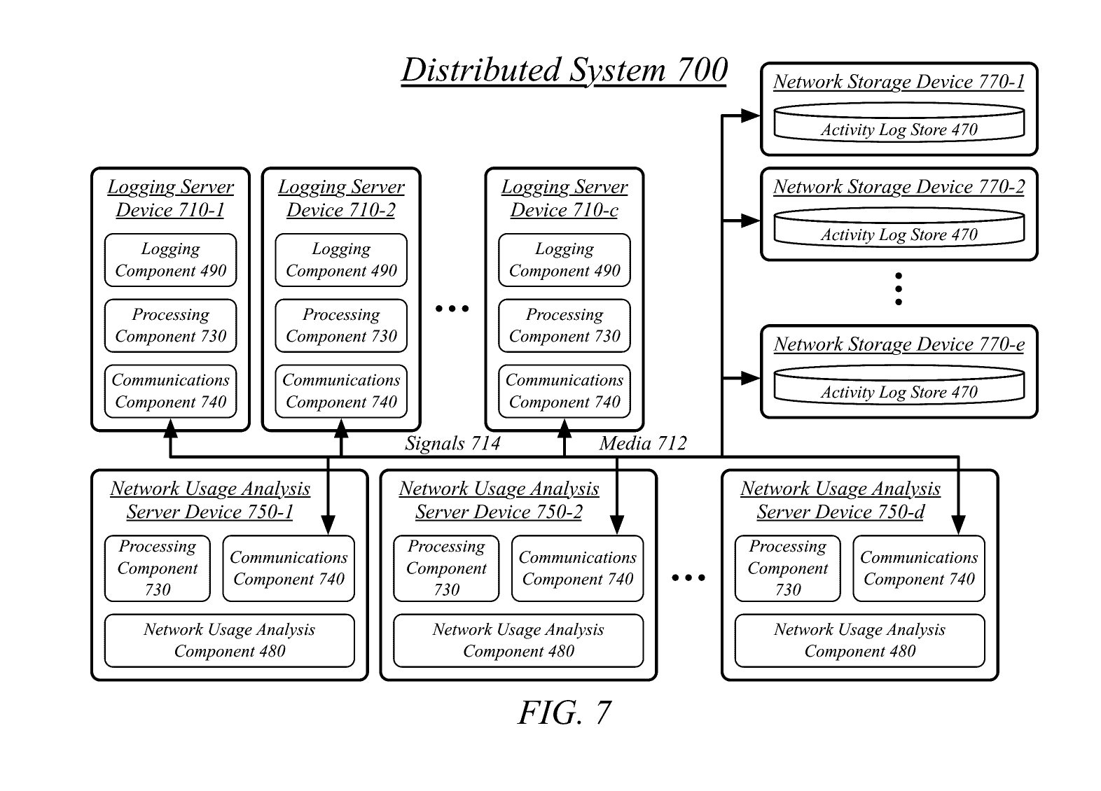

FIG. 7 illustrates a block diagram of a distributed system 700. The distributed system 700 may distribute portions of the structure and/or operations for the video transfer detection system 100 across multiple computing entities. Examples of distributed system 700 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 700 may comprise logging server devices 710, network usage analysis server devices 750, and network storage devices 770. In general, the devices 710, 750 may be the same or similar to the client centralized server device 620 as described with reference to FIG. 6. For instance, the devices 710, 750 may each comprise a processing component 730 and a communications component 740 which are the same or similar to the processing component 630 and the communications component 640, respectively, as described with reference to FIG. 6. In another example, the devices 710, 750 may communicate over a communications media 712 using communications signals 714 via the communications components 740.

The logging server devices 710 may comprise or employ one or more server programs that operate to perform various methodologies in accordance with the described embodiments. In one embodiment, for example, the logging server devices 710 may each implement a logging component 490. The logging server devices 710 may be operative to communicate with client devices, such as client device 120, using communications signals 714.

The network usage analysis server devices 750 may comprise or employ one or more server programs that operate to perform various methodologies in accordance with the described embodiments. In one embodiment, for example, the network usage analysis server devices 750 may each implement a network usage analysis component 480.

The network storage devices 770 may comprise or employ one or more server programs that operative to perform various methodologies in accordance with the described embodiments. In one embodiment, for example, the network storage devices 770 may each implement an activity log store 470.

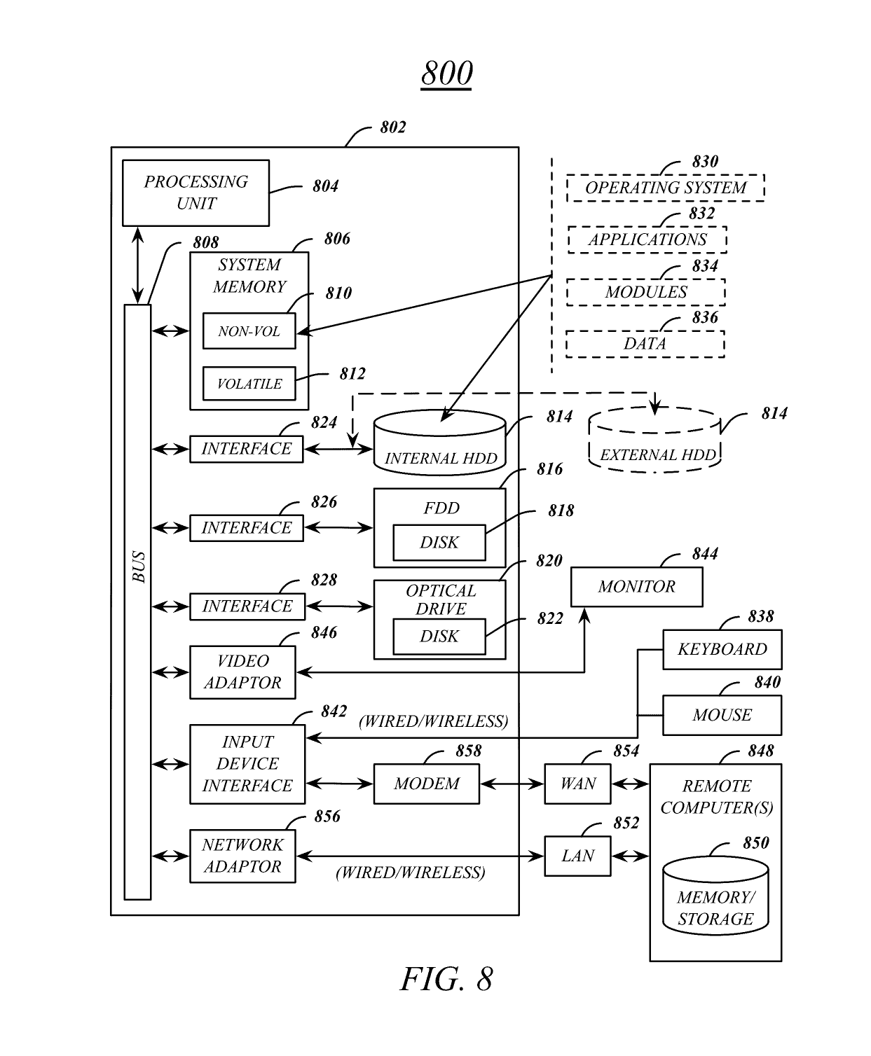

FIG. 8 illustrates an embodiment of an exemplary computing architecture 800 suitable for implementing various embodiments as previously described. In one embodiment, the computing architecture 800 may comprise or be implemented as part of an electronic device. Examples of an electronic device may include those described with reference to FIG. 6 and FIG. 7, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the video transfer detection system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.8 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.8x (a, b, g, n, etc.) to provide secure, reliable, fast wireless connectivity. A Wi-Fi network can be used to connect computers to each other, to the Internet, and to wire networks (which use IEEE 802.3-related media and functions).

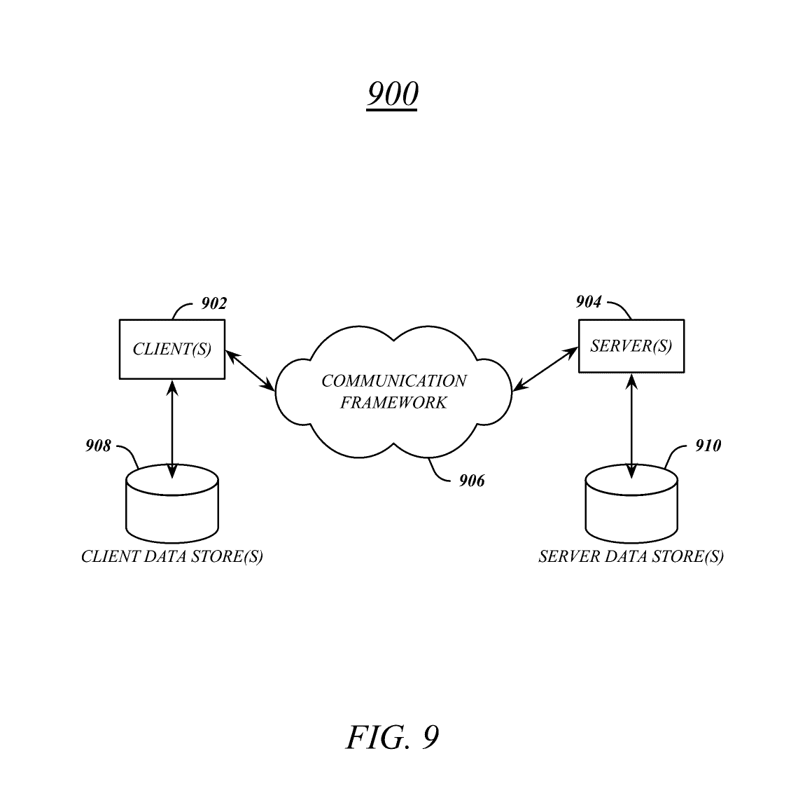

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 may implement client devices such as client device 120. The servers 904 may implement server devices 710, 750. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

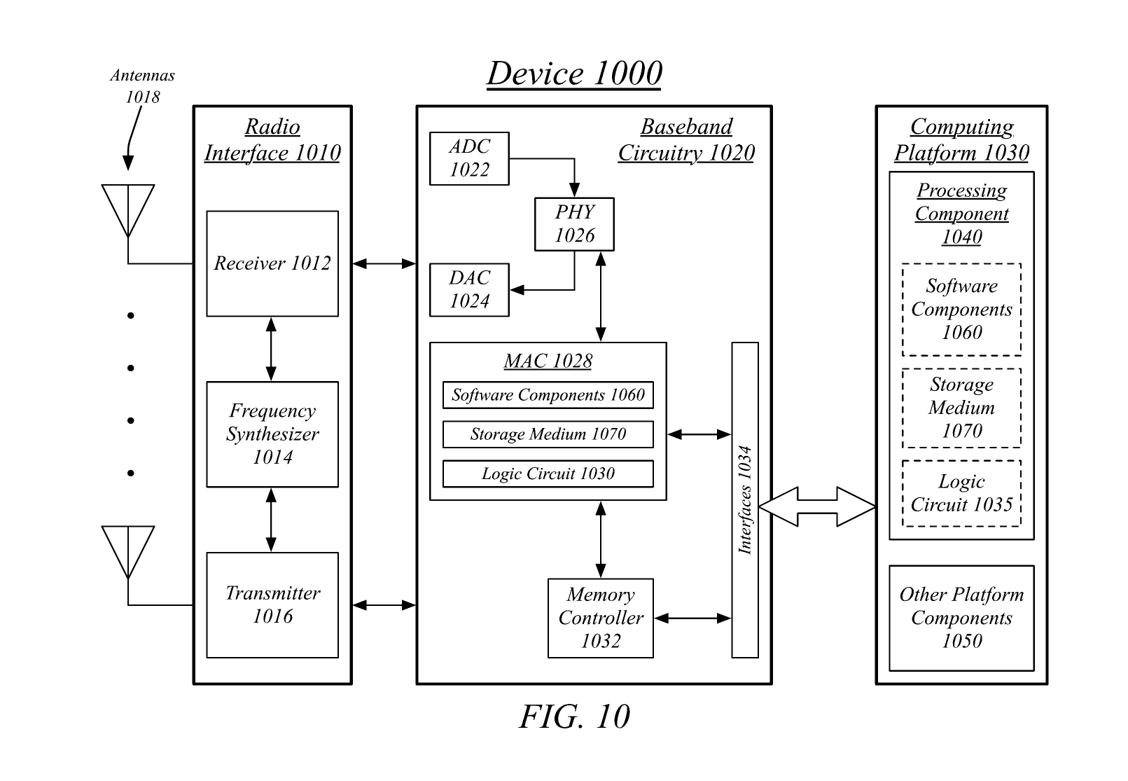

FIG. 10 illustrates an embodiment of a device 1000 for use in a multicarrier OFDM system, such as the video transfer detection system 100. Device 1000 may implement, for example, software components 1060 as described with reference to video transfer detection system 100 and/or a logic circuit 1035. The logic circuit 1035 may include physical circuits to perform operations described for the video transfer detection system 100. As shown in FIG. 10, device 1000 may include a radio interface 1010, baseband circuitry 1020, and computing platform 1030, although embodiments are not limited to this configuration.

The device 1000 may implement some or all of the structure and/or operations for the video transfer detection system 100 and/or logic circuit 1035 in a single computing entity, such as entirely within a single device. Alternatively, the device 1000 may distribute portions of the structure and/or operations for the video transfer detection system 100 and/or logic circuit 1035 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1010 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1010 may include, for example, a receiver 1012, a transmitter 1016 and/or a frequency synthesizer 1014. Radio interface 1010 may include bias controls, a crystal oscillator and/or one or more antennas 1018. In another embodiment, radio interface 1010 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1020 may communicate with radio interface 1010 to process receive and/or transmit signals and may include, for example, an analog-to-digital converter 1022 for down converting received signals, a digital-to-analog converter 1024 for up converting signals for transmission. Further, baseband circuitry 1020 may include a baseband or physical layer (PHY) processing circuit 1056 for PHY link layer processing of respective receive/transmit signals. Baseband circuitry 1020 may include, for example, a processing circuit 1028 for medium access control (MAC)/data link layer processing. Baseband circuitry 1020 may include a memory controller 1032 for communicating with processing circuit 1028 and/or a computing platform 1030, for example, via one or more interfaces 1034.

In some embodiments, PHY processing circuit 1026 may include a frame construction and/or detection module, in combination with additional circuitry such as a buffer memory, to construct and/or deconstruct communication frames, such as radio frames. Alternatively or in addition, MAC processing circuit 1028 may share processing for certain of these functions or perform these processes independent of PHY processing circuit 1026. In some embodiments, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for the video transfer detection system 100 and logic circuit 1035 using the processing component 1040. The processing component 1040 (and/or PHY 1026 and/or MAC 1028) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired. In some embodiments, device 1000 may be configured to be compatible with protocols and frequencies associated one or more of the 3GPP LTE Specifications and/or IEEE 1002.16 Standards for WMANs, and/or other broadband wireless networks, cited herein, although the embodiments are not limited in this respect.

Embodiments of device 1000 may be implemented using single input single output (SISO) architectures. However, certain implementations may include multiple antennas (e.g., antennas 1018) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise determining a foreground application on a device; monitoring network usage for the foreground application on the device; determining whether the network usage for the foreground application exceeds a video usage signature threshold; and logging video activity in a video usage time series log where the network usage for the foreground application exceeds the video usage signature threshold.

A computer-implemented method may further comprise determining video usage statistics for the device based on the video usage time series log.

A computer-implemented method may further comprise wherein monitoring network usage for the foreground application comprises accessing an operating system network usage log for the device.

A computer-implemented method may further comprise wherein determining the foreground application on a device includes determining that a display for the device is active and is unlocked.

A computer-implemented method may further comprise determining whether the network usage is video network service associated; determining whether the network usage for the foreground application exceeds the video usage signature threshold using a first video usage signature threshold where the network usage is video network service associated; determining whether the network usage for the foreground application exceeds the video usage signature threshold using a second video usage signature threshold where the network usage is not video network service associated, the first video usage signature threshold lower than the second video usage signature threshold.

A computer-implemented method may further comprise generating a foreground application time series log, the video usage time series log and the foreground application time series log indexed to a common polling schedule; and determining application-specific video usage statistics based on a comparison of the video usage time series log and the foreground application time series log.

A computer-implemented method may further comprise transmitting the video usage time series log to an analysis server, the analysis server operative to determine video usage statistics for the device based on the video usage time series log.

A computer-implemented method may further comprise generating a foreground application time series log, the video usage time series log and foreground application time series log indexed to a common polling schedule; transmitting the video usage time series log to an analysis server; and transmitting the video usage time series log to the analysis server, the analysis server operative to determine application-specific video usage statistics based on a comparison of the video usage time series log and the foreground application time series log.

An apparatus may comprise a processor circuit on a device; a network usage monitoring component operative on the processor circuit to determine a foreground application on a device; monitor network usage for the foreground application on the device; and determine whether the network usage for the foreground application exceeds a video usage signature threshold; and a logging component operative to log video activity in a video usage time series log where the network usage for the foreground application exceeds the video usage signature threshold. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
determining a foreground application on a device;
monitoring network usage for the foreground application on the device;
determining whether the network usage for the foreground application exceeds a video usage signature threshold; and
logging a first state in a video usage time series log at a first time when the network usage for the foreground application exceeds the video usage signature threshold, and logging a second state in the video usage time series log at a second time when the network usage for the foreground application is below the video usage signature threshold, the first state indicative of video transfer activity and the second state indicative of no video transfer activity.

2. The method of claim 1, comprising:
determining video usage statistics for the device based on the video usage time series log.

3. The method of claim 1, wherein monitoring network usage for the foreground application comprises accessing an operating system network usage log for the device.

4. The method of claim 1, wherein determining the foreground application on a device includes determining that a display for the device is active and is unlocked.

5. The method of claim 1, comprising:
determining whether the network usage is video network service associated;
determining whether the network usage for the foreground application exceeds the video usage signature threshold using a first video usage signature threshold where the network usage is video network service associated; and
determining whether the network usage for the foreground application exceeds the video usage signature threshold using a second video usage signature threshold where the network usage is not video network service associated, the first video usage signature threshold lower than the second video usage signature threshold.

6. The method of claim 1, comprising:
generating a foreground application time series log, the video usage time series log and the foreground application time series log indexed to a common polling schedule; and
determining application-specific video usage statistics based on a comparison of the video usage time series log and the foreground application time series log.

7. The method of claim 1, comprising:
transmitting the video usage time series log to an analysis server, the analysis server operative to determine video usage statistics for the device based on the video usage time series log.

8. The method of claim 1, comprising:
generating a foreground application time series log, the video usage time series log and foreground application time series log indexed to a common polling schedule;
transmitting the video usage time series log to an analysis server; and
transmitting the video usage time series log to the analysis server, the analysis server operative to determine application-specific video usage statistics based on a comparison of the video usage time series log and the foreground application time series log.

9. An apparatus, comprising:
a processor circuit on a device;
a network usage monitoring component operative on the processor circuit to determine a foreground application on a device; monitor network usage for the foreground application on the device; and determine whether the network usage for the foreground application exceeds a video usage signature threshold; and
a logging component operative to log a first state in a video usage time series log at a first time when the network usage for the foreground application exceeds the video usage signature threshold, and logging a second state in the video usage time series log at a second time when the network usage for the foreground application is below the video usage signature threshold, the first state indicative of video transfer activity and the second state indicative of no video transfer activity.

10. The apparatus of claim 9, further comprising:
a network usage analysis component operative to determine video usage statistics for the device based on the video usage time series log.

11. The apparatus of claim 9, wherein monitoring network usage for the foreground application comprises accessing an operating system network usage log for the device.

12. The apparatus of claim 9, further comprising:
the network usage monitoring component operative to determine whether the network usage is video network service associated; determine whether the network usage for the foreground application exceeds the video usage signature threshold using a first video usage signature threshold where the network usage is video network service associated; and determine whether the network usage for the foreground application exceeds the video usage signature threshold using a second video usage signature threshold where the network usage is not video network service associated, the first video usage signature threshold lower than the second video usage signature threshold.

13. The apparatus of claim 9, further comprising:
the logging component operative to generate a foreground application time series log, the video usage time series log and the foreground application time series log indexed to a common polling schedule; and
a network usage analysis component operative to determine application-specific video usage statistics based on a comparison of the video usage time series log and the foreground application time series log.

14. The apparatus of claim 9, further comprising:
the logging component operative to generate a foreground application time series log, the video usage time series log and foreground application time series log indexed to a common polling schedule; transmit the video usage time series log to an analysis server; and transmit the video usage time series log to the analysis server, the analysis server operative to determine application-specific video usage statistics based on a comparison of the video usage time series log and the foreground application time series log.

15. At least one non-transitory computer-readable storage medium comprising instructions that, when executed, cause a system to:
determine a foreground application on a device;
monitor network usage for the foreground application on the device;
determine whether the network usage for the foreground application exceeds a video usage signature threshold; and
log a first state in a video usage time series log at a first time when the network usage for the foreground application exceeds the video usage signature threshold, and logging a second state in the video usage time series log at a second time when the network usage for the foreground application is below the video usage signature threshold, the first state indicative of video transfer activity and the second state indicative of no video transfer activity.

16. The computer-readable storage medium of claim 15, comprising further instructions that, when executed, cause a system to:
determine video usage statistics for the device based on the video usage time series log.

17. The computer-readable storage medium of claim 15, wherein monitoring network usage for the foreground application comprises accessing an operating system network usage log for the device.

18. The computer-readable storage medium of claim 15, comprising further instructions that, when executed, cause a system to:
determine whether the network usage is video network service associated;
determine whether the network usage for the foreground application exceeds the video usage signature threshold using a first video usage signature threshold where the network usage is video network service associated; and
determine whether the network usage for the foreground application exceeds the video usage signature threshold using a second video usage signature threshold where the network usage is not video network service associated, the first video usage signature threshold lower than the second video usage signature threshold.

19. The computer-readable storage medium of claim 15, comprising further instructions that, when executed, cause a system to:
generate a foreground application time series log, the video usage time series log and the foreground application time series log indexed to a common polling schedule; and
determine application-specific video usage statistics based on a comparison of the video usage time series log and the foreground application time series log.

20. The computer-readable storage medium of claim 15, comprising further instructions that, when executed, cause a system to:
generate a foreground application time series log, the video usage time series log and foreground application time series log indexed to a common polling schedule;
transmit the video usage time series log to an analysis server; and
transmit the video usage time series log to the analysis server, the analysis server operative to determine application-specific video usage statistics based on a comparison of the video usage time series log and the foreground application time series log.
